(19) United States
(12) Patent Application Publication
(10) Pub. No.: US 2022/0116673 A1
(43) Pub. Date: Apr. 14, 2022

(54) APPARATUS AND METHOD FOR DELIVERING ADVERTISEMENT CONTENT TO CONNECTED VEHICLES

(71) Applicants: Inje CHO, Seoul (KR); Hoonje CHO, Seoul (KR)

(72) Inventors: Inje CHO, Seoul (KR); Hoonje CHO, Seoul (KR)

(21) Appl. No.: 17/535,684

(22) Filed: Nov. 25, 2021

Related U.S. Application Data
(62) Division of application No. 16/248,991, filed on Jan. 16, 2019, now abandoned.
(60) Provisional application No. 62/618,569, filed on Jan. 17, 2018.

(30) Foreign Application Priority Data
May 4, 2018 (KR) 1020180052082

(51) Int. Cl. H04N 21/414; H04N 21/436; H04N 21/442; H04N 21/422; H04N 21/2668; H04N 21/81

(52) U.S. Cl. CPC H04N 21/41422; H04N 21/436; H04N 21/812; H04N 21/422; H04N 21/2668; H04N 21/44231

(57) ABSTRACT

Systems and methods for increasing an effect of advertisement delivery are provided. The system includes a server and a connected vehicle. The server may be coupled to a database of advertisements and the connected vehicle having external and internal displays may be coupled to the server. Based on input by a user of the connected vehicle from a starting location to a destination, the connected vehicle may be configured to determine a first maximum reward route, which may be determined based in part on a maximum driving distance, a maximum driving time, or a sum of rewards within a route. The connected vehicle may be configured to receive one or more advertisements from the server for reproduction, which are selected based in part on location information of the connected vehicle, local time information, or attributes of people around the connected vehicle. As a result, the advertisements delivery effect is greatly increased.

### CROSS-REFERENCE TO RELATED APPLICATION(S)

The present application is a divisional application of U.S. patent application Ser. No. 16/248,991, filed Jan. 16, 2019, which claims the benefit of U.S. Provisional Patent Application No. 62/618,569, filed Jan. 17, 2018, titled “Vehicle for Providing Advertisement and Method of Delivering Advertisement Using Thereof,” and related Korean Patent Application No. KR10-2018-0052082, filed May 4, 2018, the entire contents of which are incorporated by reference herein in its entirety.

### TECHNICAL FIELD

The present disclosure relates to an apparatus for delivering advertisement contents over a network, in particular, delivering the advertisement contents to one or more connected vehicles over the network in a connected environment.

### BACKGROUND

As modern technology advances, internet connected devices are gaining more popularity and are becoming more common place in people's everyday lives. Further, commercial advertisements are taking various delivery technology formats such as internet, webpages, you-tubes, mobile phones, smart TVs, etc. away from traditional formats such as newspapers, magazines, TVs, and billboards.

Also, nowadays vehicles such as taxis or public transportation buses are displaying more advertisements for profit, via stickers or special paints, on the sides of the vehicles so that passerby people can view them. However, these delivery platforms are static in nature and are very limited in that the advertisements are attached to the vehicle for a duration of time that is agreed between the vehicle owner and an advertiser. Further, the advertisements don't change during an entire vehicle route.

As such, there is still a need for a new, improved, and innovative method or technique for delivering advertisement contents to vehicles for the purpose of increasing the effect of advertisement.

### SUMMARY

With the advent of autonomous vehicles and/or electric vehicles, the vehicles are more connected to a network or Internet, via various communications technology. Further, there are more connected vehicles to the Internet, which are capable of communications with a device over a wireless network as well as with other connected vehicles. That is, vehicles are becoming not only a transportation means but also devices, e.g., clients (in a client-server context), which may communicate with one or more servers over a network for retrieving various information including current news, weather data, and advertisements from the one or more servers on the network.

The present technology described herein provides a system or a method for delivering one or more advertisement contents to connected vehicles in an Internet of Things (loT) environment, in a more effective manner, thereby increasing the effect of advertisements delivered to people. That is, the present technology provides in an aspect a new, novel system or method for delivery of one or more advertisement contents for the highest possible effect to the viewers, using the connected vehicles as part of an advertisement platform.

In one embodiment of the present technology, a system for delivering advertisement contents to one or more connected vehicles over a network includes a plurality of connected vehicles in a network environment. Each of the plurality of connected vehicles may be coupled to a server over a network, and the server may be configured to manage the delivery of advertisement contents. Also, the plurality of connected vehicles may be in communications with the server via a first wireless network and each of the plurality of connected vehicles may be configured to output, via an electronic display means and/or an audio means, one or more advertisement contents. The one or more advertisement contents may be selected based in part on location information of the plurality of connected vehicles, local time information, or attributes of people (e.g., age, sex, preferences, etc.) around the plurality of connected vehicles.

In another aspect of the present disclosure, the electronic display means of each connected vehicle may include an internal display disposed inside the connected vehicle or an external display disposed outside the connected vehicle for reproducing the one or more advertisement contents.

In an aspect of the present disclosure, the audio means of each connected vehicle may include an internal speaker disposed inside the connected vehicle or an external speaker disposed outside the connected vehicle for reproducing the one or more advertisement contents.

In an aspect of the present disclosure, the server is configured to transmit the one or more advertisement contents to the plurality of connected vehicles.

In an aspect of the present disclosure, each of the connected vehicles is configured to transmit and/or receive the one or more advertisement contents to or from other connected vehicles via a second wireless network.

In an aspect of the present disclosure, the first wireless network comprises: a cellular communications network, a Wi-Fi communications network, or a satellite communication network.

In an aspect of the present disclosure, each of the plurality of connected vehicles is configured to send to the server over the wireless network, location information of the connected vehicle, and the location information includes at least one of: a global positioning system (GPS) information or proximity information of other nearby connected vehicles.

In an aspect of the present disclosure, each of the plurality of connected vehicles is equipped with one or more ultra-wideband (UWB) transceivers for determining the proximity information of other nearby connected vehicles.

In another embodiment of the present disclosure, the plurality of connected vehicles includes a first connected vehicle, and a second connected vehicle, and the first connected vehicle precedes the second connected vehicle in a direction.

In an aspect of the present disclosure, in the system, the first connected vehicle of the plurality of connected vehicles may be configured to output an advertisement content on an external display of the first connected vehicle, and the second connected vehicle of the plurality of connected vehicles may be configured to: detect and identify the advertisement content displayed on the external display of the connected vehicle, and reproduce, inside the second connected vehicle, an audio advertisement content relating to the advertisement content displayed on the external display of the first connected vehicle.

Further, in an aspect of the present disclosure, the second connected vehicle may be configured to search for at least one audio file relating to the advertisement content displayed on the external display of the first connected vehicle, and when multiple audio files are found, select an audio file based on a predetermined priority for reproduction of the audio advertisement content.

In an aspect of the present disclosure, the second connected vehicle may be further configured to reproduce, inside the second connected vehicle, the audio advertisement content when it is determined that the second connected vehicle is within a predetermined distance from the first connected vehicle.

In another aspect of the present disclosure, the first connected vehicle may be configured to turn off the reproduction of the audio advertisement content on the external display of the first connected vehicle when the first connected vehicle is within a certain distance from a destination by a user of the first connected vehicle.

In another aspect of the present disclosure, the second connected vehicle may be configured to: detect an audio advertisement that is being reproduced inside the second connected vehicle, search for at least one video file relating to the detected audio advertisement and send the at least one video file to the first connected vehicle for reproduction. Further, the first connected vehicle may be configured to: receive the at least one video file from the second connected vehicle, and reproduce a visual advertisement content of the at least one video file on an external display of the first connected vehicle, such that the visual advertisement content relating to the audio advertisement that is being reproduced inside the second connected vehicle is presented to occupants in the second connected vehicle.

In another aspect of the present disclosure, the first connected vehicle may be further configured to receive from the server the at least one video file for reproducing the visual advertisement content on the external display of the first connected vehicle.

In another aspect of the present disclosure, when the second connected vehicle determines that multiple video files relating to the audio advertisement exist, the video file for reproduction may be selected according to a predetermined priority.

In another aspect of the present disclosure, to provide privacy to the occupants in the connected vehicles, the first connected vehicle may be configured to turn off the reproduction of the visual advertisement content on the external display of the first connected vehicle when the first connected vehicle is within a certain distance from a destination set by a user of the first connected vehicle.

In another aspect of the present disclosure, to increase an effect of the advertisement, when one of the connected vehicles detects an advertisement content displayed within a distance, the first connected vehicle may be configured to display the advertisement content on an external display of the one of the connected vehicles such that the advertisement content is additionally reproduced to viewers.

In another aspect of the present disclosure, the one of the connected vehicles may be configured to reproduce, via an in-vehicle audio system of the one of the connected vehicles, an audio relating to the advertisement content displayed on the external display of the one of the connected vehicles.

In another aspect of the present disclosure, when the one of the connected vehicles is within a certain distance of a destination, the one of the connected vehicles may be configured to turn off the reproduction of the advertisement content displayed on the external display of the one of the connected vehicles.

In another embodiment of the present disclosure, a system for delivering advertisement contents includes: a server over a network, and a connected vehicle including a few external displays and an internal display. The connected vehicle may be coupled to the server over the network via a wireless network. Further, the connected vehicle may be configured to receive the one or more advertisement contents from the server via the wireless network and reproduce the one or more advertisement contents via either the external display or the internal display.

In an aspect of the present disclosure, in the system above, the server may be further configured to provide one or more rewards to a user of the connected vehicle and/or an external viewer, when the external viewer obtains the identification information from the one or more advertisement contents reproduced on the external display of the connected vehicle and takes an action based on the obtained identification information.

In an aspect of the present disclosure, the action of the external view may include an access to a predetermined website based on the obtained identification information, via a mobile device of the external viewer.

In an aspect of the present disclosure, the one or more rewards may comprise a discount rental fee, an additional use time, or a credit for use next time for the connected vehicle.

In another aspect of the present disclosure, the connected vehicle may be configured to provide a user of the connected vehicle with a first maximum reward route, via a graphical user interface (GUI), from a starting location to a destination.

In an aspect of the present disclosure, the first maximum reward route may be determined based at least in part on: a maximum driving distance, a maximum driving time, or a sum of rewards within a route.

In an aspect of the present disclosure, a value of the sum of rewards may be determined based on an expected advertisement effect, as the connected vehicle passes through a specific region, a specific road, and/or a specific store.

In an aspect of the present disclosure, when a deviation of the connected vehicle from the first maximum reward route, the connected vehicle may be configured to determine a second maximum reward route and present to the user of the connected vehicle the second maximum reward route.

In another aspect of the present disclosure, the server may be configured to provide a reward to a user of the connected vehicle when the user inputs a suitable reply in response to a prompt provided by an advertiser via an in-vehicle audio within a predetermined period. In an aspect of the present disclosure, the suitable reply includes words or phrases including specific keywords or phrases.

In another embodiment of the present technology, an apparatus for delivering advertisement contents include one or more connected vehicles, each of which is configured to output, via an electronic display means and/or audio means, one or more advertisement contents that are selected based in part on location information of the one or more connected vehicles, local time information, or attributes of people (e.g., age, sex, preferences, etc.) around the plurality of connected vehicles.

For example, the one or more advertisement contents may be selected based on a local time of a day. That is, in a big city, certain advertisement contents relating to sale of drinks, bars, or etc. may be selected for reproduction after 6 p.m. and other advertisement contents such as stores, or events may be selected for reproduction during the day. In another aspect of the present disclosure, the one or more advertisement contents may be also selected based on attributes of people (e.g., age, sex, preferences, etc.) surrounding the connected vehicle.

In another aspect of the present disclosure, each of the connected vehicles may be configured to communicate with other connected vehicles via a wireless network.

In another embodiment of the present technology, a connected vehicle may be configured to detect an advertisement content displayed on a structure within a distance, where the connected vehicle is configured to reproduce the advertisement content on an external display or an internal display of the connected vehicle such that an effect of the advertisement content can be increased by additionally reproducing the advertisement content inside and/or outside of the connected vehicle. The structure may include a building, a billboard, or a vehicle. Further, in an aspect of the present disclosure, the connected vehicle may be further configured to reproduce, via an in-vehicle audio system (e.g., speaker(s)) of the connected vehicle, an audio advertisement content relating to (or corresponding to) the advertisement content displayed on the structure, and reproduce, via the external display or the internal display of the connected vehicle, a visual advertisement content relating to (or corresponding to) the advertisement content displayed on the structure.

As such, in various aspects of the present disclosure, the effect of the advertisement may be significantly increased by reproducing the one or more advertisement contents, based in part on location information, local time information, or attributes of people around the connected vehicles, using one or more connected vehicles as advertisement platforms.

The following brief description of the drawings and the detailed description of the exemplary embodiments of the present technology are provided for better understanding of the present technology.

### BRIEF DESCRIPTION OF THE DRAWINGS

A more detailed understanding may be obtained from the following description in conjunction with the following accompanying drawings.

FIG. 1 is an overall network diagram conceptually illustrating an example embodiment of the present technology in accordance with an aspect of the present disclosure;

FIGS. 2A-2C are diagrams conceptually illustrating example embodiments of the present technology in accordance with an aspect of the present disclosure;

FIG. 3 is a diagram conceptually illustrating an example embodiment of the present technology in accordance with an aspect of the present disclosure;

FIGS. 4A and 4B conceptually illustrate example embodiments of the present technology in accordance with an aspect of the present disclosure;

FIGS. 5A and 5B conceptually illustrate example embodiments of the present technology in accordance with an aspect of the present disclosure;

FIGS. 6A and 6B conceptually illustrate example embodiments of the present technology in accordance with an aspect of the present disclosure;

FIGS. 7A and 7B conceptually illustrate example embodiments of the present technology in accordance with an aspect of the present disclosure;

FIGS. 8A-8C illustrate example embodiments of the present technology in accordance with an aspect of the present disclosure; and

FIG. 9 is a block diagram conceptually illustrating an example of an embodiment in accordance with an aspect of the present disclosure.

### DETAILED DESCRIPTION

The detailed description of illustrative examples will now be set forth below in connection with the various drawings. The description below is intended to be exemplary and in no way limit the scope of the claimed invention. It also provides a detailed example of possible implementation(s) and is not intended to represent the only configuration(s) in which the concepts or present technology described herein may be practiced. Further, the detailed description includes specific details for providing a thorough understanding of various concepts, and it is noted that these concepts may be practiced without these specific details. In some instances, well known structures and components are shown in block diagram form to avoid obscuring such concepts or clarity of presentation. Also, it should be noted that like reference numerals are used in the drawings to denote like elements and features.

While the methodologies are described herein sometimes as a series of steps or acts, for simplicity, the claimed subject matter is to be understood to not be limited by the order of these steps or acts, as some steps or acts may occur in different orders and/or concurrently with other acts from that shown and described herein. Further, not all illustrated steps or acts may be required to implement various methodologies according to the present technology disclosed herein. Also, it should be appreciated that the apparatus and methods described herein may be utilized separately or in combination with other aspects of the present disclosure, or in combination with conventional technology, without departing from the teachings of the present disclosure or technology.

In the present disclosure, various terms or phrases as used herein are defined as fellows. The phrase “advertisement content(s)” is used to mean any content, either audio advertisement or visual advertisement for a product, a service, including but not limited thereto, videos, audios, live TV broadcasts, news, weather, mission, surveys, votes, interactive games, etc. that may be delivered via one or more audio, image, or video files in various formats. The term “audio advertisement content” or “audio content” is used herein to mean an audio component of an advertisement. The term “visual advertisement content” or “visual content” is used herein to mean a visual or image component of an advertisement.

The term “connected vehicle(s)” is used herein to mean one or more vehicles, either stationary or moving, which are capable of being connected to a network, e.g., an Internet protocol (IP) network, and can communicate with one or more computing devices over the network. The connected vehicles may include some interior spaces for one or more occupants, e.g., a driver or passengers in the vehicle for transportation purposes and may be autonomous vehicles as well as non-autonomous vehicles.

The term “coupled to” or its variations are used herein to mean being connected to or in communication with, e.g., a certain device over a network via various network protocols.

The term “a display means” or its variations are used herein to mean a display device including certain electronic display means, including but not limited to, a liquid crystal display (LCD) display, a light emitting diode (LED) display, an organic LED (OLED) display, or other types of display which is capable of outputting one or more visual advertisement contents. The term “audio means” is used herein to mean any type of audio means including, but not limited to, one or more speakers which are capable of outputting audio or sounds.

The term “location information” is used herein to mean certain information or data including, but not limited to, location data which are determined based on global positioning system (GPS), cellular signals, Wi-Fi signals, beacon signals, etc. The term “proximity information” is used herein to mean certain position information of an object relative to another object, and may include distance information among two or more objects, based on technologies such as, including but not limited thereto, ultra-wideband (UWB), War, laser, camera, ultrasonic waves, etc.

The term “preceding” is used herein to mean being ahead of or in front of at a certain distance between two or more connected vehicles which may be stationery or moving in a direction.

The term “billboard” is used herein to mean a general structure displaying one or more advertisements, such as a stationery structure, e.g., a conventional billboard, a wall of a building, etc., or a display disposed on a side of a vehicle, which may be stationary or moving. Also, the billboard may include one or more computing devices.

The term “a discount rental fee” is used herein to mean a code or coupon for a discount for a rental fee of a connected vehicle. The term “a maximum reward route” is used herein to mean a route in which one can collect a maximum amount of rewards possible using or riding in a connected vehicle. The term “an expected advertisement effect” is used herein to mean an effect of advertisement including both quantifiable and non-quantifiable effects. An example expected advertisement effect may be a numerical value assigned to a number of viewers of an advertisement during a ride in a connected vehicle.

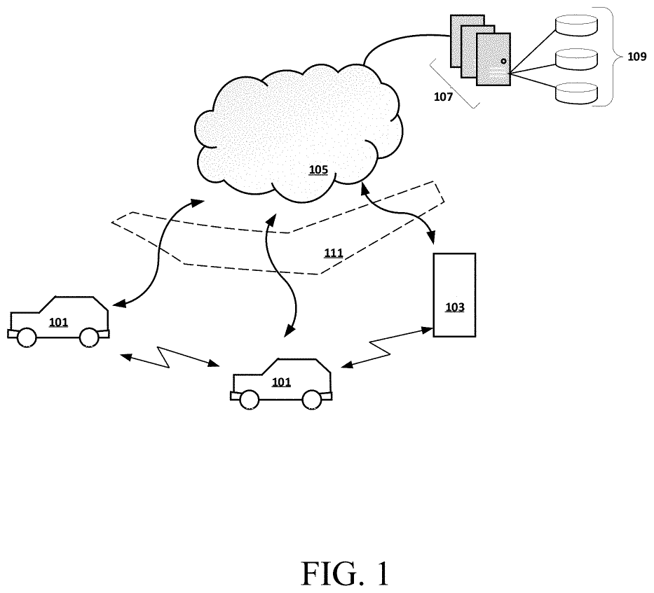

FIG. 1 is a diagram conceptually illustrating an example embodiment of the present technology in accordance with an aspect of the present disclosure. FIG. 1 illustrates a high-level system including various components such as one or more clients 101 or 103, a network 105, one or more servers 107, and one or more databases 109. The one or more clients 101 may include one or more connected vehicles 101 or advertisement structures 103, which are coupled to the network 105 via a first wireless network 111. The first wireless network 111 may be implemented using various telecommunications technologies, such as cellular technology and/or data communications technology including but not limited thereto, the 4^{th} Generation (4G), the 5^{th} Generation (5G), or any other advanced future generation telecommunications technologies, which are based on Internet Protocol (IP) or its variants. The network 105 may be composed of one or more public or private networks connecting the one or more clients 101 and 103 to one or more servers 107 over a network. The one or more servers 107 may be coupled to one or more databases 109, which may contain various types of data, including but not limited thereto, a database of advertisement contents, a database of user profiles, a database of advertiser profiles, a database of news and other information (e.g., news, videos, audios, broadcasts, weather news, missions, surveys or votes, interactive games, etc.) and a database of the clients 101 and 103. Further, the one or more servers 107 may be implemented to perform various functions, including but not limited thereto, management and control of delivery of advertisement contents to the one or more clients 101 or 103 over the first wireless network 111. Also, the one or more servers 107 may include account management functions for the advertisement contents, advertisers, and users. The account management functions may include subscriptions, reward payments, etc. Further the one or more servers 107 may be implemented in a single computer or multiple computers in a distributed manner.

In an aspect of the present disclosure, the one or more connected vehicles 101 may be configured to receive one or more advertisement contents from the one or more servers 107, based in part on location information of the one or more connected vehicles 101, via the network 105 and the wireless network 111, and output the one or more advertisement contents to occupants inside the one or more connected vehicles 101 or viewers outside. As such, the one or more connected vehicles 101 may serve as clients in a client-server environment. Also, in another aspect of the present disclosure, the one or more advertisement contents may be determined based on a local time and other factors such as attributes of people (e.g., age, sex, preferences, etc.) around the connected vehicles, in addition to the location information of the connected vehicles 101.

Also, in the example, the one or more connected vehicles 101 are each configured to collect and send to the one or more servers 107 identification information of the connected vehicles, such as vehicle identification number, user, driver or owner information. Further, the one or more connected vehicles 101 may be configured to collect and send to the one or more servers 107 location information of the connected vehicles, e.g., global positioning system (GPS), ultra-wideband data, etc., as well as current vehicle status data such as speed, temperature, operating conditions, etc.

Furthermore, the one or more connected vehicles 101 are each configured to receive command and/or data from the one or more servers, such as advertisement contents, news, or other types of data that are to be reproduced inside the connected vehicles 101 or outside on external displays of the connected vehicles 101, Alternatively, the one or more connected vehicles 101 are each configured to take appropriate actions in response to certain commands front the one or more servers 107 over the network.

Further, as shown in FIG. 1, the client 103 may include a building or structure, such as a billboard, equipped with displays and speakers for reproducing one or more advertisement contents. In another aspect of the present disclosure, the client 101 or 103 may be configured to send certain data to server(s) 107 over the network, such as current location information, identification information, environmental conditions including surrounding conditions, a micro dust amount in air, temperature, noise, etc., and to receive from the servers 107 certain commands and/or information, in response, and process the received commands and/or information for one or more actions, e.g., display or reproduce information on the external displays of the clients 101 or 103. By way of example, the servers 107 may be configured to receive sensory data about the micro dust amount in air from the client 101 or 103 disposed at a certain location, and send certain commands and/or data in response, e.g., warning or alert messages, to the client 101 or 103 so that the warning or alert messages may be reproduced on the external displays of the client 101 or 103 for the public

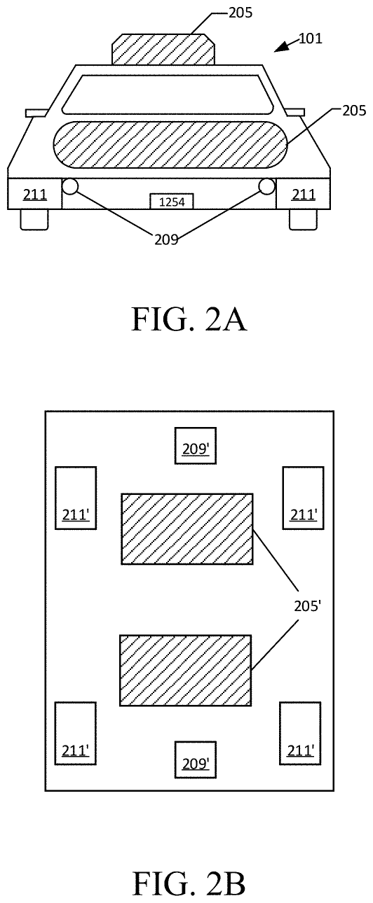

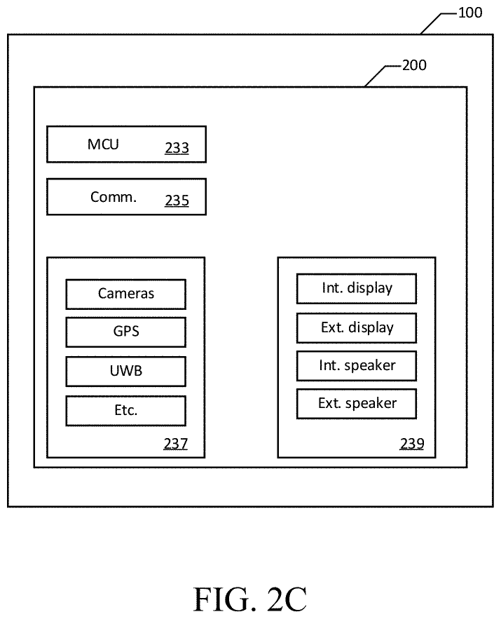

FIGS. 2A-2C illustrate example embodiments of the present technology in an aspect of the present disclosure. By way of example, as shown in FIGS. 2A and 2B, each connected vehicle 101 may be equipped with various devices inside and outside. First, as shown in FIG. 2A, the connected vehicle 101 may be equipped with one or more external displays 205, one or more external speakers 211, and one or more external cameras 209, for reproducing one or more advertisement contents for viewers outside the connected vehicle 101. Further, the connected vehicle 101 may include inside one or more internal displays 205′, one or more internal speakers 211′, and one or more internal cameras 209′, for reproducing one or more advertisement contents for occupants including drivers and/or passengers in the connected vehicle 101.

FIG. 2C illustrate a block diagram conceptually illustrating components of an advertisement system 200 which may be part of a connected vehicle 101 in an aspect of the present disclosure. By way of example, the advertisement system 200 of FIG. 2C may be included in a vehicle, such as a connected vehicle as shown in FIGS. 1, 4A, 5A, 6A, and 7A. The advertisement system 200 of FIG. 2C may also include, but not limited thereto, various components such as a main control unit (ICU) 233, a communication unit 235, a sensor unit 237, an output unit 239, and optionally one or more databases.

In the example described herein, the main control unit 233 may be configured for management and control of devices or units of the advertisement system 200 for the reproduction of one or more advertisement contents via the connected vehicle to increase the effect of advertisement. The communication unit 235 may be coupled to the main control unit 233 and may be configured to communicate with the one or more servers 107 over the network 105 or with other connected vehicles 101 or structures 103, as shown in FIG. 1. Also, as for the communications with the one or more servers 107 over the network 105, various wireless telecommunications technologies such as the third generation (3G), the fourth generation (4G) or the fifth generation (5G) telecommunications technology may be used as the enabling technology for voice as well as high-speed data services with Internet connectivity.

Further, in an aspect of the present disclosure, the communication unit 235 of the advertisement system 200 may be configured to include various transceivers that are needed for communicating with other connected vehicles 101 or structures 103. For example, the wireless technologies such as Wi-Fi or other vehicular communication technologies, e.g., vehicle to vehicle (V2V), vehicular ad hoc networks (VANETs), or the like may be used for communications between the connected vehicles 101 or between the connected vehicles 101 and the structures 103. In one implementation, V2V may be used between the connected vehicles 101, which is an automobile technology designed to allow automobiles to communicate with each other and is designed to use a region of 5.9 GHz band, and Wi-Fi may be used for communications between the connected vehicles 101 and the structures 103.

Furthermore, the sensor unit 237 of the advertisement system 200 may include a GPS, ultra wideband (UWB) transceivers, cameras, vehicular sensors, environmental sensors, etc. to collect various information and data relating to the connected vehicle 101 as well as the surrounding environments. By way of example, the GPS of the sensor unit 237 may be used to collect rough location information of the connected vehicle 101, e.g., GPS coordinates, and the UWB transceivers may be used to obtain relative location or more granular location information of the connected vehicle 101 with respect to other connected vehicles nearby. In another implementation, the sensor unit 237 may include one or more location identification systems based on cellular signals, Wi-Fi signals, or beacons. Also, in another implementation, the sensor unit 237 of the advertisement system 200 may include other location identification systems based on lidar, laser, ultrasonic waves, or the like. Further, the sensor unit 237 of the advertisement system 200 may include one or more cameras configured to capture images in real-time of inside as well as outside of the connected vehicle, the images of which will be further processed various purposes including identification of one or more advertisements, people, attributes of people (e.g., age, sex, preferences, etc.), for example.

In an aspect of the present disclosure, in the example, one or more external cameras of the connected vehicle may be used to recognize or detect, in cooperation with other software and/or hardware components, one or more advertisement contents displayed on other connected vehicles or stationery or moving structures, such as billboards, trucks, buses, building walls, or etc. The one or more external cameras of the connected vehicle may be used to determine certain traits of people, such as age, sex, preferences, etc. by processing images of the people outside the connected vehicle, for the purpose of reproducing one or more suitable advertisement contents on the external displays and/or speakers of the connected vehicle based on the determined trains of people. Further, in an aspect of the present disclosure, one or more internal cameras of the connected vehicle may be used to recognize or detect, in cooperation with other software and/or hardware components, certain data relating to one or more occupants in the connected vehicle, including a driver as well as passengers. Further, the one or more internal cameras of the connected vehicle may be used to determine certain traits of people, such as age, sex, preferences, etc. by processing images of the people inside the connected vehicle, for the purpose of reproducing one or more suitable advertisement contents on the internal displays and/or speakers of the connected vehicle based on the determined trains of people.

Additionally, the advertisement system 200 in the connected vehicle 101 may optionally include one or more databases comprising a database of advertisement contents, a database of advertisers, and/or profiles of drivers, users, or owner of the connected vehicle 101, etc. In an aspect of the present disclosure, the one or more databases of the advertisement system 200 may be used to reproduce advertisement contents including visual advertisement contents and audio advertisement contents for the connected vehicle 101 or other connected vehicles 101, without retrieving the advertisement contents from the one or more servers 107 over the first wireless network 111. Further, the one or more databases may include advertisement contents, news, weather, videos, audios, broadcasts, user profiles, driver profiles, vehicle owner profiles, vehicle status profiles, or many others. As noted above, as used herein, the “advertisement content” includes both audio and visual components, e.g., audio advertisement content and visual advertisement content. The user profiles may include various information on a user of the connected vehicle, including but not limited thereto, personal data including name, age, sex, shopping preferences, past use history, etc. The driver profiles may include various information on a driver of the connected vehicle, including but not limited thereto, personal data including name, age, sex, shopping preferences, past use history, driving habits, etc. The vehicle owner profiles may include various information on a vehicle owner, including but not limited thereto, personal data including name, age, sex, shopping preferences, driving habits, etc.

Further, in another aspect of the present disclosure, the one or more databases of the advertisement system 200 disposed in the connected vehicle 101 may be automatically updated on a regular basis over the first wireless network 111 from the one or more servers 107 over the network 105.

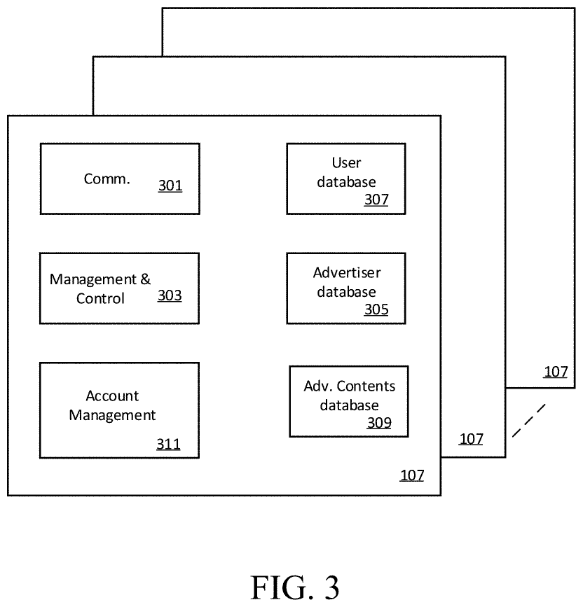

FIG. 3 illustrates a diagram conceptually illustrating various components of one or more servers over a network for managing and delivering advertisement contents to connected vehicles. By way of example, in an aspect of the present disclosure, a server 107 includes a communications unit 301 and a management and control unit 303. The server 107 may further include, or alternatively coupled to, one or more databases, including but not limited thereto, a database of advertisement contents 305, a database of user profiles 307, a database of advertiser profiles 309, and an account management unit 311. Further, in another aspect of the present disclosure, various functionalities or databases may be implemented in multiple servers in a distributed manner.

In an aspect of the present disclosure, the communication unit 301 of the server 107 may be configured to include a receiving unit (not shown) configured to receive certain data (e.g., location information, status data, etc.) from one or more clients 101 or 103 and a transmitting unit (not shown) configured to send commands and/or data including advertisement contents to the clients 101 or 103. Also, the management and control unit 33 of the server 107 may be configured to manage and control the connected vehicles as well as delivery of the advertisement contents to the connected vehicles. Further, the account management unit 311 of the server 107 may be configured to store and manage accounting data (e.g., subscription status, rewards status, payment status, etc.) relating to the users, drivers, vehicle owners, as well as advertisers. The account management unit 311 of the server 107 may be configured to administer payment of one or more rewards to the users, drivers, or vehicle owners when certain actions are taken, which the advertisers specify relating to the advertisement contents that are reproduced via the connected vehicles.

Furthermore, in an aspect of the present disclosure, the database of advertisement contents 305 may be configured to include one or more advertisement contents that are to be delivered to the connected vehicles over the network. As noted above, each advertisement content may include both audio and visual components, e.g., audio advertisement content and visual advertisement content. Also, the one or more advertisement contents may be selected and delivered to the connected vehicles over the network, based on certain information such as, including but not limited thereto, location information of the connected vehicles, local time information, or attributes of people (e.g., age, sex, preferences, etc.) around the connected vehicles, or when a certain condition is satisfied.

In another aspect of the present disclosure, the database of user profiles 307 may be configured to include one or more profiles of users (including drivers) of a connected vehicle, e.g., user information, including but not limited thereto, name, age, sex, personal preferences, shopping habits, an amount of rewards, etc.

Further, in an aspect of the present disclosure, the database of advertisers 305 may be configured to include one or more profiles of advertisers, e.g., advertiser information, including but not limited thereto, name, location, type of business, advertisement contents, reward payment criteria, etc.

Furthermore, the one or more servers 107 may include (or be coupled to) databases of other types of information such as current news, weather information, podcasts, live broadcasts, videos, audios, etc. that may be of interest to the public.

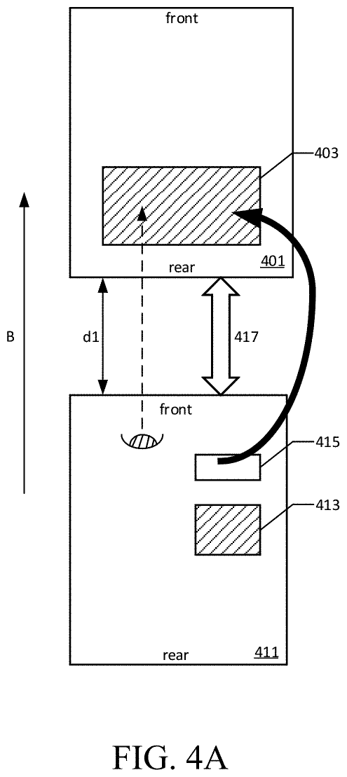

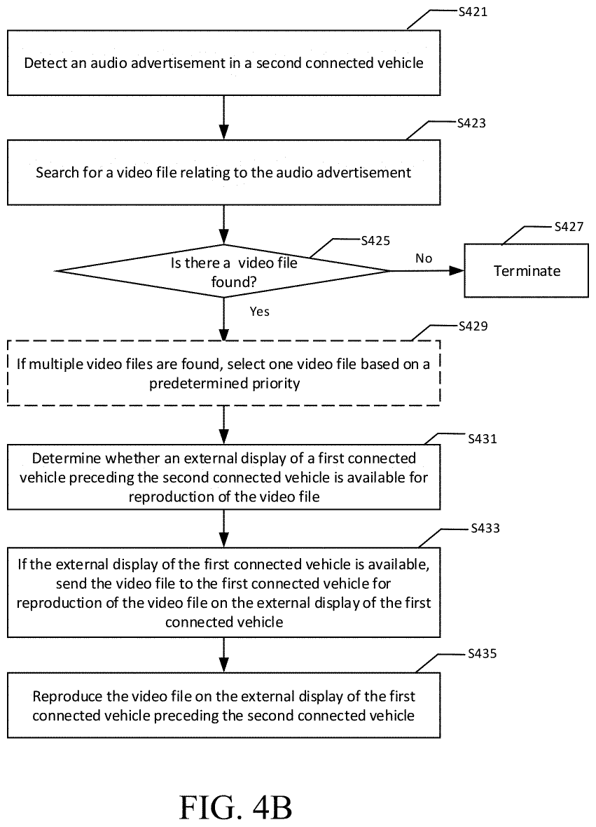

FIGS. 4A and 4B illustrate another embodiment of the present technology in accordance with an aspect of the present disclosure. In FIG. 4A, the example illustrates that two connected vehicles 401 and 411 are moving in a same direction at a distance d1, with the first connected vehicle 401 preceding the second connected vehicle 411. Both the first connected vehicle 401 and the second connected vehicle 411 may maintain communications with the server 107 over the network, as shown in FIG. 1. Further, both connected vehicles may send via a first wireless network (e.g., 3G. 4G, 5G, satellite based, etc.) to the server 107 location and proximity information of the first connected vehicle 401 and the second connected vehicle 411, such that the server 107 may determine one or more advertisement contents that are to be delivered to the connected vehicles based on the location (e.g., GPS location) and/or proximity (e.g., relative positions) information of the first connected vehicle 401 and the second connected vehicle 411. Also, the first connected vehicle 401 and the second connected vehicle 411 may communicate with each other via a second wireless network 417, e.g., V2V technology.

In an aspect of the present disclosure, in the example, when the second connected vehicle 411 detects a reproduction of an audio advertisement content inside the second connected vehicle, e.g., occupants are listening to an audio advertisement content through a radio station 415, the second connected vehicle 411 may search for a visual advertisement content, e.g., a video file, relating to or corresponding to the audio advertisement content in an advertisement database in the second connected vehicle 411.

When one or more video files relating to or corresponding to the audio advertisement content are found in the advertisement database, the second connected vehicle 411 may determine whether the first connected vehicle 401 preceding the second connected vehicle 411 is available for reproduction of the one or more video files on an external display 403 of the first connected vehicle 401 so that occupants in the second connected vehicle 411 may see the visual advertisement content of the one or more video files. When it is determined that the first connected vehicle 401 preceding the second connected vehicle 411 is available for the reproduction of the visual advertisement content of the one or more video files, the second connected vehicle 411 sends the one or more video files along with command data via the second wireless network 417 to the first connected vehicle 401 for the reproduction of the visual advertisement content of the video files on an external display 403 that is disposed on the first connected vehicle 401. That is, for example, the advertisement system of the first connected vehicle 401 receives via the second wireless network 417 and reproduces the visual advertisement content of the one or more video files on the external display 403 of the first connected vehicle 401, thereby increasing an effect of the advertisement to the occupants in the second connected vehicle 411 in such a way that the visual advertisement content is presented to the occupants including a driver and/or passenger(s) of the second connected vehicle 411, while the driver and/or passenger(s) of the second connected vehicle 411 are listening to the audio advertisement content that is reproduced in the second connected vehicle 411.

In an aspect of the present disclosure, as noted above, the video files max be sent from the second connected vehicle 411 to the first connected vehicle 401 via the second wireless network 417 such as the vehicle to vehicle (QV) communication technology. In another aspect of the present disclosure, however, the video files may be sent from the second connected vehicle 411 to the first connected vehicle 401 via the first wireless network 111 through a cloud.

In another aspect of the disclosure, the video files may be sent from the server 107 to the first connected vehicle 401 via the first wireless network 111. That is, the search for the video files relating to the audio advertisement content may also be conducted by the server 107 over the network and the corresponding or related video files that are found by the search may be sent to the connected vehicle 401 by the server 107 over the first wireless network 111.

Still in another aspect of the present disclosure, when multiple video files relating to the audio advertisement content are found, a video file may be selected based in part on one or more predetermined conditions. The one or more predetermined conditions (or criteria) may include location of the connected vehicles 401 and 411, preferences of viewers in the second connected vehicle 411, types, size, and capability of the external display of the first connected vehicle 401 preceding the second connected vehicle 411, etc. By way of example, the location of the connected vehicles 401 and 411 may be used to determine which advertisement contents need to be reproduced. In one implementation, one or more advertisement contents for a retail store nearby may be selected for reproduction. Alternatively, the location of the connected vehicles as well as profiles of users of the connected vehicles may be considered together to select a best matched advertisement content that is to be reproduced on the connected vehicle. Also, the one or more predetermined conditions may be set in a variety of manners in advance and stored in the server 107, and the one or more predetermined conditions may be part of an advertiser profile.

Further, in another aspect of the present disclosure, the reproduction of the visual advertisement content on the external display 403 of the first connected vehicle 401 may continue if the predetermined distance d1 between the first connected vehicle 401 and the second connected vehicle 411 is maintained. However, when the predetermined distance d1 is greater than a certain threshold value, the reproduction of the visual advertisement content on the external display 403 of the first connected vehicle 401 may be stopped. Alternatively, when the first connected vehicle 401 is out of visual reach of the occupants in the second connected vehicle 411, the reproduction of the visual advertisement content on the first connected vehicle 401 may be stopped.

Furthermore, in another aspect of the present disclosure, when the connected vehicle 401 is close or with a certain distance to a destination set by a driver, or a user (or passenger) in the first connected vehicle 401, the reproduction of the visual advertisement content on the external display 401 of the first connected vehicle 401 may be stopped and power to the external display 403 of the first connected vehicle 401 may be turned off such that personal privacy of the driver, user or passengers in the first connected vehicle 401 may be kept when they get off art the destination.

FIG. 4B illustrates a high-level flowchart for an example embodiment in accordance with an aspect of the present disclosure. In the example it is assumed that a first connected vehicle precedes a second connected vehicle and that occupants are listening to the audio advertisement, e.g., via a radio system, in the second connected vehicle. At S421, the audio advertisement is detected in the second connected vehicle. The detection of the reproduction of the audio advertisement may be done by an advertisement system, e.g., via in vehicle microphone(s) in conjunction with one or more processors, based on specific keywords or phrases or identifying information in the second connected vehicle. Also, one or more internal cameras may be used to detect the reproduction of the audio advertisement in the second connected vehicle.

After the detection of the audio advertisement, at S423, a search is made for a video file relating to the audio advertisement. In the example, the search is made by the advertisement system in the connected vehicle by using specific keywords or phrases that are detected or captured during the reproduction of the audio advertisement. The detected specific keywords or phrases are using against an onboard database of advertisement contents for a match. Alternatively, the connected vehicle may transmit the detected specific keywords or phrases to a server over the network for the search in a query and response fixmat.

At S425, when a video file relating to (or corresponding to) the audio advertisement is found, then the second connected vehicle communicates with the first connected vehicle to determine whether one or more external display of the first connected vehicle is available for reproduction of the video file. Further, if no video file is found relating to (or corresponding to) the audio advertisement, then the procedure terminates.

Further, as at S429, when multiple video files are found relating to the audio advertisement, then one video file may be selected according to a predetermined priority. By way of example, the predetermined priority may include preferences such as a profile of a user, a profile of an advertiser, a duration of an advertisement time, etc.

At S433, when an external display of the first connected vehicle preceding the second connected vehicle is determined to be available for use, e.g., reproduction of the video file, then the second connected vehicle may send a copy of the video file to the first connected vehicle via a wireless network, e.g., V2V communications technology, or another wireless communications technology. In the example, the video image file along with other control data (e.g., a time duration of the video file, a marker for synchronized reproduction of the visual advertisement content, etc.) may be sent to the first connected vehicle.

After receiving the video file and the control data from the second connected vehicle, at S435, the first connected vehicle (or the advertisement unit of the first connected vehicle) reproduces the video file on an external display of the first connected vehicle based on the received control data. In another aspect of the present disclosure, the video file along with the control data may be delivered to the first connected vehicle over a wireless network by a server like the server 107 in FIG. 1. Further, in another aspect of the present disclosure, in the event that the first connected vehicle has a copy of the video file in a database of advertisement contents in the first connected vehicle, the first connected vehicle may communicate with the second connected vehicle and receives only the control data from the second connected vehicle for the purpose of reproducing the video file on the external display of the first connected vehicle.

As such, in a situation where two connected vehicles are moving together one preceding the other, and when an audio advertisement content is detected of being reproduced in a rear connected vehicle, a visual advertisement content relating to or corresponding to the audio advertisement content may be reproduced on an external display of a front connected vehicle preceding the rear connected vehicle, such that the advertisement content can be visually presented to occupants in the rear connected vehicle, thereby increasing the effect of the advertisement to the occupants in the rear connected vehicle.

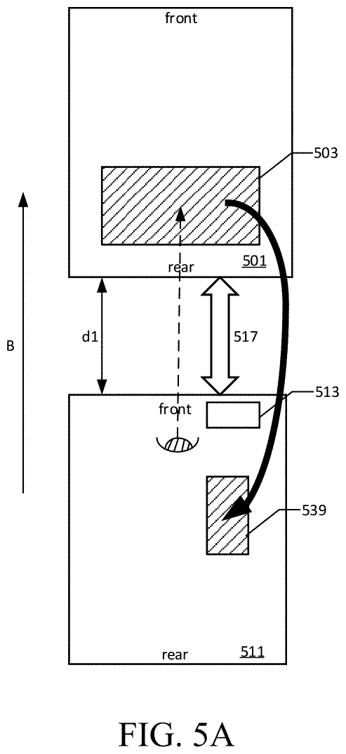

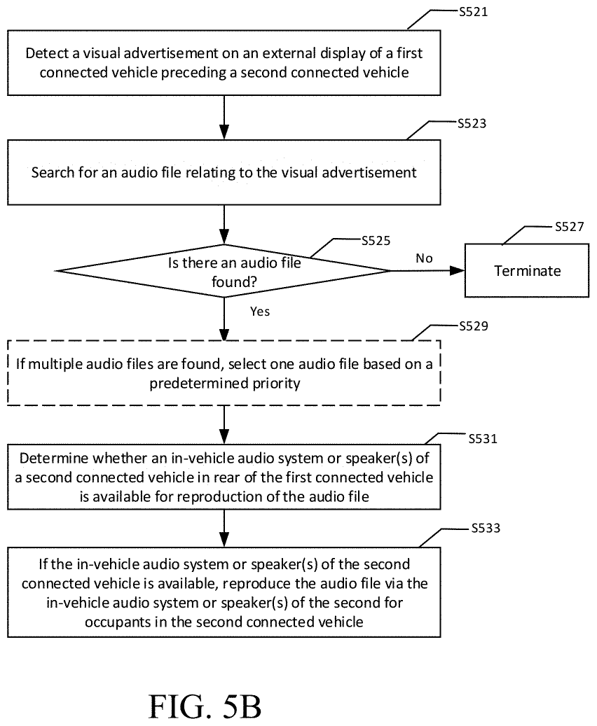

FIGS. 5A and 5B illustrate an example embodiment of the present technology in accordance with an aspect of the present disclosure. In FIG. 5A, two connected vehicles 501 and 511 are moving in a same direction B at a distance d2 apart, with a first connected vehicle 501 preceding a second connected vehicle 511. Each of the first connected vehicle 501 and the second connected vehicle 511 may be in communications with the server 107 over the network, as shown in FIG. 1. As described above, the connected vehicles 501 and 511 may be each configured to send to the server 107 location information and proximity information of the first connected vehicle 501 and the second connected vehicle 511, respectively. Also, as shown in FIG. 5A, it is assumed that the first connected vehicle 501 precedes the second connected vehicle 511 and both connected vehicles may be in communications with each other via a wireless communications network 517, such as V2V technology.

In an aspect of the present disclosure, the second connected vehicle 511 may detect a reproduction of a visual advertisement content outside on an external display 503 of the first connected vehicle 501, e.g., via one or more cameras 513 mounted onto the second connected vehicle 511, The detection of the visual advertisement content may be performed by using identification information embedded in the visual advertisement content, e.g., a QR code, or the like. Further, in one implementation, upon detection of the visual advertisement content, the second connected vehicle 511 may search for an audio advertisement content, e.g., one or more audio files, relating to or corresponding to the visual advertisement content in a database of advertisement contents in the second connected vehicle 511. As noted above, the database of advertisement contents (or an advertisement database) may include both audio and visual advertisement components, e.g., an audio advertisement content and a visual advertisement content for each advertisement content.

In the example shown in FIG. 5A, when an audio file relating to or corresponding to the visual advertisement content displayed on the external display of the first connected vehicle 501 is found in the advertisement database of the second connected vehicle 511, the second connected vehicle 511 is configured to determine whether the second connected vehicle 511 following the first connected vehicle 501 is available for reproducing one or more audio files via an in-vehicle audio system of the second connected vehicle 511. When the second connected vehicle 511 following the first connected vehicle 501 is determined to be available for the reproduction of the audio advertisement content, e.g., the in-vehicle audio systems are available, the second connected vehicle 511 reproduces the audio file via the in-vehicle audio system, e.g., internal speaker(s) such that the audio advertisement content of the audio file is presented to a driver or occupant(s) in the second connected vehicle 511 while the visual advertisement content relating to the audio advertisement content is reproduced on the external display 503 of the first connected vehicle 501. That is, for example, the second connected vehicle 511 is configured to reproduce, via the advertisement system of the second connected vehicle 511, the audio advertisement content corresponding to the visual advertisement content displayed on the external display 503 of the first connected vehicle 501 in such a way that the driver and/or occupants of the second connected vehicle 511 may listen to the audio advertisement content while viewing the visual advertisement content that relates to the audio advertisement content on the external display 503 of the first connected vehicle 501.

In the example shown in FIG. 5A, in another aspect of the disclosure, a search for the audio file relating to the visual advertisement content displayed on the external display 503 of the connected vehicle 501 may be conducted by the server 107 over the network, as shown in FIG. 1, rather than by the second connected vehicle 511. When the search is performed by the server 107 over the network, corresponding or related audio files that are found may be transmitted to the second connected vehicle 511 from the server 107 over the wireless network, such that the second connected vehicle 511 receives the audio files and reproduce them via one or more in-vehicle audio systems 539 of the second connected vehicle.

Still in another aspect of the present disclosure, when multiple audio files relating to the visual advertisement content are found, an audio file may be selected based in part on one or more predetermined conditions, for reproducing the audio advertisement content via one or inure in-vehicle audio systems in the second connected vehicle 511. The one or more predetermined conditions (or criteria) may include present location of the connected vehicles 501 and 511, preferences or profiles of occupants in the second connected vehicle 511, etc. Also, the one or more predetermined conditions may be set in advance and stored in the connected vehicles or the server 107 over the network and may be part of an advertiser profile or a user profile.

Further, in another aspect of the present disclosure, the reproduction of the audio advertisement content in the second connected vehicle 511 may be performed if the predetermined distance d2 between the first connected vehicle 501 and the second connected vehicle 511 remains under a predetermined threshold value. When the predetermined distance becomes greater than the predetermined threshold value, the reproduction of the audio advertisement content in the second connected vehicle 511 may be stopped. Alternatively, when the first connected vehicle 501 is out of visual reach of the occupants in the second connected vehicle 511, the reproduction of the audio advertisement content in the second connected vehicle 511 may also be stopped.

Furthermore, in another aspect of the present disclosure, when the first connected vehicle 501 comes close to a destination set by a driver, a user (or passenger) of the first connected vehicle 501, the reproduction of the visual advertisement content on the external display 503 of the first connected vehicle 501 may be stopped and power to the external display 503 of the first connected vehicle 501 may be turned off so as to provide personal privacy of the driver, user or passengers in the first connected vehicle 501. Also, in an aspect of the present disclosure, the reproduction of the audio advertisement content in the second connected vehicle 511 may be stopped when the reproduction of the visual advertisement content on the first connected vehicle is stopped,

FIG. 5B illustrates an example flowchart of an embodiment in accordance with an aspect of the present disclosure.

In the example of FIGS. 5A and 5B, it is assumed that a first connected vehicle precedes a second connected vehicle and that occupants in the second connected vehicle are presented with a visual advertisement content reproduced on an external display of the first connected vehicle.

At S521, the visual advertisement content on the external display of the first connected vehicle is detected by the second connected vehicle. By way of example, the visual advertisement may be recognized and/or detected by one or more cameras mounted on the second connected vehicle in conjunction with image processing software. Certain identification information embedded in the visual advertisement content such as a QR code for the advertisement content, vehicle identification number, etc. may be used for identifying the visual advertisement content. The identification information may further include, but not limited thereto, information on a specific advertisement content, advertiser, an advertisement duration, a preferred location profile, etc.

At S523, after detecting the visual advertisement content on the external display of the first connected vehicle is identified, a search is made for an audio file relating to or corresponding to the visual advertisement content. In the example, the search may be performed by the advertisement system of the connected vehicle based on the identification information and a database of advertisement contents in the second connected vehicle. Alternatively, the second connected vehicle may transmit the identification information of the visual advertisement content to a server over a network for the search and subsequently receive from the server one or more audio files relating to or corresponding to the visual advertisement content displayed on the external display of the first connected vehicle.

At S525 and 5531, when an audio file relating to (or corresponding to) the visual advertisement content is found, then the second connected vehicle is configured to determine whether one or more internal display of the second connected vehicle is available for reproduction of the audio file. Further, if no audio file is found relating to (or corresponding to) the visual advertisement content reproduced on the external display of the first connected vehicle, then the procedure terminates, at S527.

Alternatively, or optionally, as at S529, when multiple audio files are found relating to the visual advertisement content, then an audio file may be selected according to a predetermined priority. By way of example, the audio file may be selected based on the predetermined priority such as location, preferences, a profile of a user, a profile of an advertiser, a duration of an advertisement time, etc.

At S533, when the in-vehicle audio system of the second connected vehicle disposed in the rear of the first connected vehicle is determined to be available for use, e.g., reproduction of the audio file, then the second connected vehicle may reproduce the audio file via the in-vehicle audio system, e.g., internal speaker(s) of the second connected vehicle, in a synchronized manner with the visual advertisement content displayed on the external display of the first connected vehicle.

Further, in another aspect of the present disclosure, in the event that the first connected vehicle has a copy of the audio file in a database of advertisement contents in the first connected vehicle, the first connected vehicle may communicate with the second connected vehicle and send the audio file along with control data for the purpose of reproducing the audio file via the in-vehicle audio system of the second connected vehicle in a substantially synchronized manner. Alternatively, the audio file may be retrieved from the server over the network, and the audio file may be reproduced via the in-vehicle audio system of the second connected vehicle.

As such, in a situation where two connected vehicles are moving together one preceding the other, and when a visual advertisement content is displayed on an external display of a first connected vehicle preceding a second connected vehicle, the visual advertisement content may be detected by the second connected vehicle, and an audio advertisement content relating to the visual advertisement content may be reproduced via in-vehicle audio system of the second connected vehicle, such that the advertisement content can be not only visually but also audibly presented to occupants in the second connected vehicle, thereby increasing the effect of the advertisement to the occupants in the second connected vehicle.

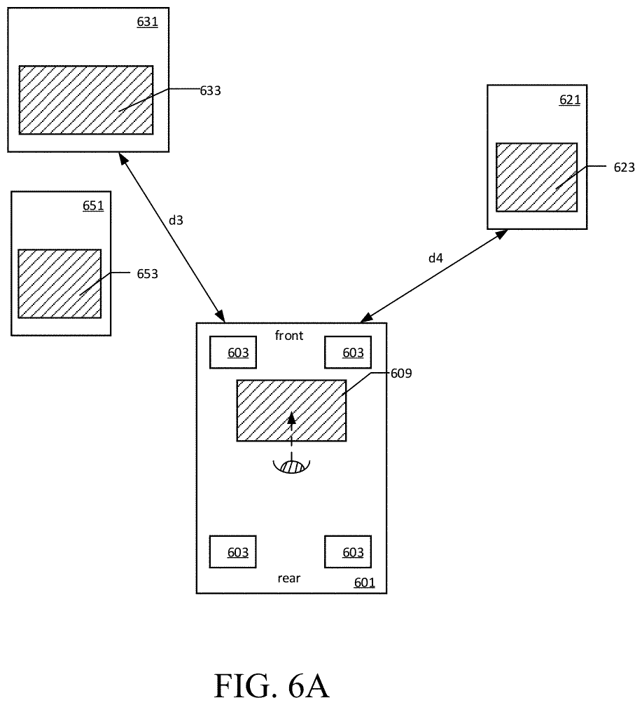

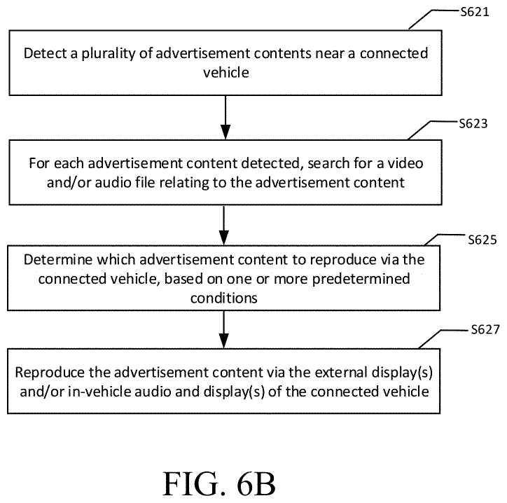

FIGS. 6A and 6B illustrate another embodiment of the present technology in accordance with an aspect of the present disclosure. For example, in FIG. 6A, a connected vehicle 601 equipped with a plurality of cameras 603 is disposed near one or more structures such as a building 621, a structure 631 (e.g., a billboard), a store 651, or other connected vehicles with advertisement content. In an aspect of the present disclosure, when the connected vehicle 601 detects one or more advertisement contents 623 633 or 653, which are displayed on a wall of the building 621, the structure 631 (e.g., a billboard or a side of a bus or vehicle), or the store 651, respectively, the connected vehicle 601 is configured to recognize and identify the one or more advertisement contents 623, 633 or 653.

In an aspect of the present disclosure, based on a predetermined condition, the connected vehicle 601 may select one of the advertisement contents 623, 633, or 653 for increasing the effect of the advertisement. By way of example, the predetermined condition may include that the selection of the advertisement is based on a paid subscriber status of the advertisers. Thus, if the store 651 is one of the advertisers that subscribed for an advertisement service using the connected vehicles, the advertisement content 653 is selected among the three detected advertisement contents and reproduced by the connected vehicle 601 for increasing the effect of advertisement. That is, the visual advertisement content and the audio advertisement content of the advertisement content 653 are reproduced either inside or outside the connected vehicle 601. The advertisement content 653 may be reproduced inside the connected vehicle 601 via in-vehicle audio systems and displays for viewing by occupants in the connected vehicle 601. Alternatively, the advertisement content 653 may be reproduced outside on one or more external displays of the connected vehicle 601 for viewing by outside people.

Further, in an aspect of the present disclosure, in the example above, after identifying the one or more advertisement contents 623, 633 or 653, the connected vehicle 601 may be configured to search for one or more audio files relating to the one or more advertisement contents 623 or 633 in a database of advertisement contents. The audio file found may be reproduced inside via the in-vehicle audio system and internal display(s) of the connected vehicle 601 for viewing by occupants in the connected vehicle 601. Also, when multiple audio files relating to or corresponding to the one or more visual advertisement contents 623 or 633 are found, a suitable audio file may be selected based in part on a predetermined priority and the selected audio file may be reproduced via one or more in-vehicle audio systems in the connected vehicle 601.

In another aspect of the present disclosure, the connected vehicle 601 is further configured to determine distances, e.g., d3 and d4, from the building 621 as well as the advertisement structure 631, respectively. When d4 is less than d3, the audio and/or visual advertisement content relating to the advertisement content 623 displayed on the wall of the building 621 may be reproduced inside the connected vehicle 601 via in-vehicle audio system(s) and/or internal display(s). Alternatively, or in addition, when d4 is less than d3, the audio and/or visual advertisement contents relating to the advertisement content 623 displayed on the wall of the building 621 may be reproduced outside the connected vehicle 601 via one or more external audio system(s), e.g., external speakers, and/or one or more external displays of the connected vehicle 601, Further, as described above, out of the two advertisement contents 623 and 633, the connected vehicle 601 may select one for reproduction of one of the advertisement contents 623 and 633 based on profiles of the advertisers, e.g., subscriber status, etc.

As such, the present technology described herein dramatically increases the effect of advertisement art a specific location by additionally reproducing the advertisement content via one or more connected vehicles nearby the specific location.

In another aspect of the present disclosure, in the example of FIG. 6A, the connected vehicle 601 may be further configured to select one for reproduction from the advertisement contents 633 and 623, based on profile information of a driver, a user, or occupant(s) in the connected vehicle 601, thereby significantly increasing the effect of the advertisement content by targeting based on profiled information.

FIG. 6B illustrates an example flowchart in accordance with an aspect of the present disclosure. At S621, a connected vehicle is configured to detect a plurality of advertisement contents near the connected vehicle, such as an advertisement on a billboard, a vehicle, a building, etc. In the example, one or Imre cameras of the connected vehicle are used to detect the plurality of advertisement contents near the connected vehicle. In an aspect of the present disclosure, the detection of the plurality of advertisement contents may be assisted by information provided by the server 107 over the network as shown in FIG. 1.

At S623, for each advertisement content detected, the connected vehicle is further configured to search for a video and/or audio file related to the advertisement content. Alternatively, the connected vehicle may receive from the server 107 over the network the video and/or audio file that are searched and related to the advertisement content.

At S625, the connected vehicle is further configured to determine which advertisement content to reproduce, based on one or more predetermined conditions. For example, the advertisement content (either a visual advertisement content or an audio advertisement content) may be selected based on a predetermined priority. In one implementation, based on profile information of a driver, a user, or occupant(s) in the connected vehicle, the advertisement content may be selected for reproduction on the connected vehicle. Alternatively, the advertisement content may be selected for reproduction based on subscriber statuses of the advertisers for different advertisement contents.

At S627, the selected or determined advertisement content is reproduced either on the external display(s) of the connected vehicle for outside viewers or via in-vehicle audio and display(s) of the connected vehicle for occupants inside. As such, the effect of advertisement may be significantly increased by increasing and/or enhancing the viewing experience of the same or similar advertisement contents using one or more connected vehicles.

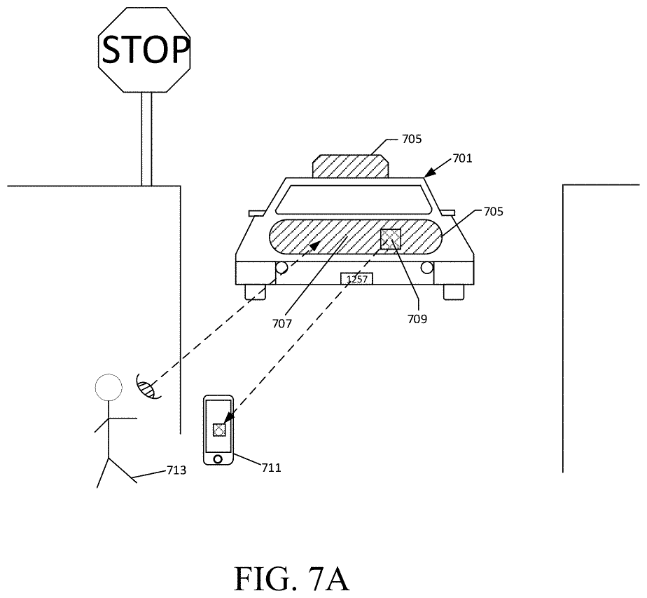

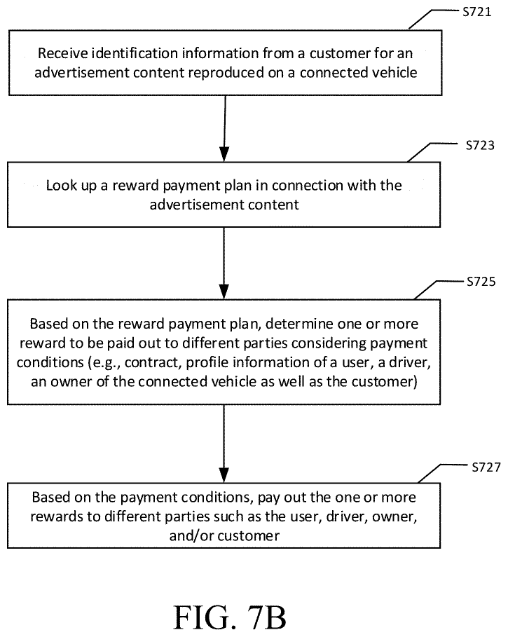

FIGS. 7A and 7B illustrate another example embodiment of the present technology in an aspect of the present disclosure. In the example shown in FIG. 7A, a connected vehicle 701 is stopped at a stop sign 703 on a road and is configured to display an advertisement content on one or more external displays 705 of the connected vehicle 701. While the connected vehicle 701 is stopped at the stop sign 703, as a pedestrian or a passer-by person 713 may see the advertisement content 707 displayed on the external display 705 of the connected vehicle 701. Then, the passer-by person 713 may obtain identification information 709 in the advertisement content 707 using his or her mobile device 711 and input the obtained identification information 709 into a predetermined website or an application on the mobile device 711. In an aspect of the present disclosure, the identification information 709 of the advertisement content 707 may include a quick response (QR) code, a vehicle identification number, an advertiser information, or the like for identification purposes.

Further, in the example above, in another aspect of the present disclosure, when the passer-by person 713 enters the obtained identification information 709 into the predetermined website or the application on the mobile device 711, data contained in the identification information 709 is sent to a server 107 as shown in FIG. 1 for various verification purposes. When the server 107 verifies the received identification information in the advertisement content 707, the server 107 may pay one or more rewards to the passer-by person 713 and/or an owner or a driver of the connected vehicle 701. In an aspect of the present disclosure, the rewards may be in the form of a discount rental fee, an additional use time, or a credit for use next time of the connected vehicle 701. Alternatively, the rewards may be in other different forms to the passer-by person and/or the owner of the connected vehicle, based on their profiles or preferences.

Furthermore, the advertisement content may be selected based on a time of a day. That is, for example, in a big city, one or more advertisement contents relating to sale of drinks, bars, or etc. may be selected for reproducing after 6 p.m. and other advertisement contents such as shopping stores or events may be selected for reproduction during the day. In another aspect of the present disclosure, the one or more advertisement contents may be also selected based on attributes of people (e.g., age, sex, preferences, etc.) surrounding the connected vehicle. That is, the connected vehicle may detect attributes of people nearby and reproduce one or more advertisement contents that are most suitable to the attributes of people nearby on the external display(s) of the connected vehicle, which is a targeted advertisement.

FIG. 7B illustrates an example flowchart in accordance with an aspect of the present disclosure. By way of example, an example reward payment scheme is illustrated. In the example, when the passer-by person 709 (or the customer) inputs the identification information into the predetermined website or the application on the mobile device 711, the server 107 of FIG. 1 is configured to receive the identification information for the advertisement content reproduced on the connected vehicle, as al S721. After receiving the identification information for the advertisement content, at S723, the server is further configured to look up a reward payment plan in connection with or associated with the advertisement content in a database. Further, at S725, based on the reward payment plan, the server is configured to determine one or more rewards to be paid out to different parties considering payment conditions such as, contract terms, profile information of a user, a driver, an owner of the connected vehicle as well as the customer. At S727, based on the payment conditions, the server is configured to pay out the one or more rewards to different parties such as the user, driver, owner of the connected vehicle, as well as the customer. As noted above, the one or rewards may be in the form of a discount rental fee of a connected vehicle, an additional use time for a connected vehicle, or a credit for use next time of a connected vehicle, or any other combination thereof. Alternatively, the one or rewards may be in the form of other discounts or services that are available from third parties. As such, according to the present technology, parties involved in the delivery of advertisement contents through connected vehicles may be additionally motivated for use and the effect of the advertisement may be significantly increased through use of one or more connected vehicles as advertisement platforms.

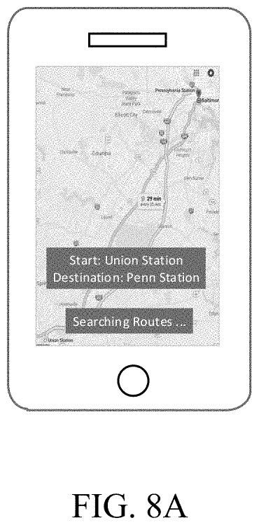

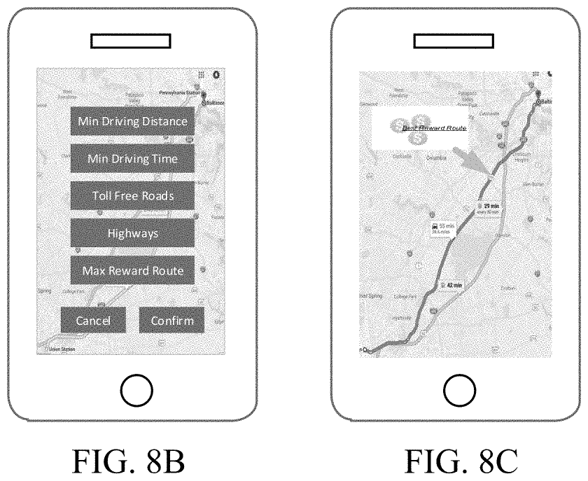

FIG. 8 illustrates another embodiment of the present technology in an aspect of the present disclosure. In an aspect of the present disclosure, a user of a connected vehicle may be presented via a graphical user interface (GUI) with an option to select a maximum reward route from a starting location to a destination, as shown in FIGS. 8A-8C. As described herein, the term “maximum reward route” is used herein to mean a route from the starting location to the destination, in which the user (driver or passenger) of the connected vehicle can collect a maximum amount of rewards in the route. As noted above, a reward may be collected by viewing advertisements and taking certain actions, e.g., scanning and inputting identifying information of the advertisement along the route.

As shown in FIG. 8A, the user or driver of the connected vehicle may enter starting location and destination location information via the GUI of an in-vehicle navigation device. Further, the GUI may also present the user or the driver of the connected vehicle with various route options such as a minimum driving distance route, a minimum driving time route, a toll-free roads route, a highway route, and a maximum reward route, as shown in FIG. 8B, When the maximum reward route is selected and confirmed via the GUI of the in-vehicle navigation device, as shown in FIG. 8C, the maximum reward route is determined based at least in part on a maximum driving distance, a maximum driving time, or a sum of rewards within a route. By way of example, in one implementation, a first sum of rewards for a maximum driving distance route may be calculated, a second sum of rewards for a maximum driving time route may be calculated. Then, the route which results in the most sum of rewards may be selected and presented to the user or deriver as the maximum reward route, as shown in FIG. 8C from the starting location to the destination location. Other methods for determining the maximum reward route may be possible based on preferences or profiles of user or driver of the connected vehicle.

Further, in another aspect of the present disclosure, a sum of rewards for a specific route may be determined based on an expected advertisement effect, as the connected vehicle passes through specific region(s), specific road(s), and/or specific store(s). That is, one or more advertisements may be associated with the specific region, the specific road, and/or the specific store, which certain actions of the user or driver of the connected vehicle are elicited for advertisement purposes. Alternatively, a value of the sum of rewards may be determined based on an expected advertisement effect in the route, as the connected vehicle passes through the specific region(s), specific road(s), and/or specific store(s). By way of example, for a retail sporting goods store may desire users or drivers of the connected vehicle who are avid hikers to view specific advertisement contents and pay rewards to them as they pass by the retail sporting goods store on the road and take specific actions in response to the advertisement contents.

In another aspect of the present disclosure, in one implementation, the server is configured to provide a reward to the user or driver of the connected vehicle when the user or driver enters specific keywords or phrases via an in-vehicle microphone in response to a prompt provided via an in-vehicle audio within a predetermined period of time after seeing the advertisement from the retail sporting goods store.

As such, by employing reward payment systems, the effect of advertisement using connected vehicles may be further increased by actively engaging users, drivers, or passengers of the connected vehicles on the road.

By way of example, when one or more advertisement contents are presented to the user (driver or passenger) of the connected vehicle, one or more rewards may be paid to predetermined parties, e.g., the user (driver or passenger) of the connected vehicle or the owner of the connected vehicle, when certain desired actions by the advertisers are taken by the user (driver or passenger) of the connected vehicle. In the example, as noted above, for the payment of rewards, the advertisers may require entry of predetermined key words or phrases by the user (driver or passenger) of the connected vehicle after one or more advertisement contents are presented to the user (driver or passenger) of the connected vehicle. Also, in an aspect of the present disclosure, the one or more rewards that to be paid out may be in the form of a discount rental fee of the connected vehicle, an additional use time of the connected vehicle, a credit for use next time of the connected vehicle, or any combination thereof. Alternatively, the one or more rewards may be in other forms such as a discount for other services or goods provided by third parties.

Employing various aspects of the present technology, as described herein, the effect of advertisement using the connected vehicles may be greatly increased, thereby providing a more effective advertising platform to advertisers or other interested parties. Although the present disclosure explains various aspects of the invention using advertisement contents, but it is not limited thereto, and as such other information may be effectively delivered via one or more connected vehicles.

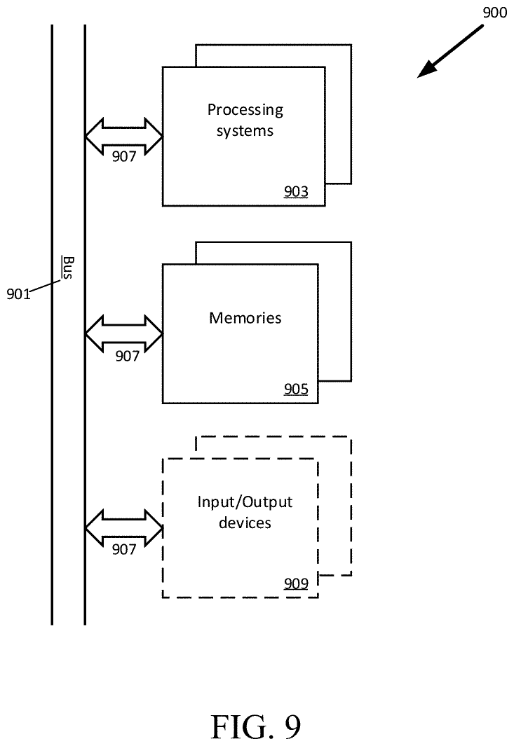

FIG. 9 illustrates an example diagram conceptually illustrating an apparatus for various functions, e.g., control and monitoring functions or unit or circuitry, in the connected vehicle 101, structures 103, and advertisement system 200 and; or the server 107. By way example, as shown in FIGS. 1-8, the advertisement system 200, various components of the advertisement system 200 (e.g., the main control unit 233, the communication unit 235, the sensor unit 237, the output unit 239, databases, or the like), the server 107, various components of the server 107 (e.g., the communication unit 301, the management and control unit 303, the account management unit 311, databases 305, 307, and 309), and other components may be implemented using in part an example apparatus 900 shown in FIG. 9.

As shown in FIG. 9, a bus 901 may link together various circuits; including one or more processing systems (or processors) 903, one or more memories (or storage units) 905, one or more communication interfaces 907, and/or optionally one or more input/output devices 909. The one or more processing systems 903 may be responsible for managing the bus and general processing, including the execution of software stored on a non-transitory computer-readable medium, relating to the one or more functions for present technology as disclosed herein.

Further, the one or more processing systems 903 may include one or more processors, such as microprocessors that interpret and execute instructions. In other implementations, the one or more processing systems 903 may be implemented as or include one or more application specific integrated circuits (ASICs), field programmable gate arrays (FPGAs), or the like. The software, when executed by the one or more processing systems 903, may cause the one or more processing systems 903 to perform the various functions described herein for any particular apparatus. The non-transitory computer-readable medium may also be used for storing data that is manipulated by the one or more processing systems 903 when executing software.

Furthermore, the one or more memories 905 may include various types of memories, including a random-access memory and/or a read only memory, and/or other types of magnetic or optical recording medium and its corresponding device for storing information and/or instructions and/or retrieval thereof. The one or more communication interfaces 907 may also include any transceiver-like mechanism that enables communication with other devices and/or systems. The one or more input/output devices 909 may include devices that permit inputting information and/or outputting information to an operator.

Even though particular combinations of features are disclosed in the specification and/or recited in the claims, these combinations are not intended to limit the disclosure of the present technology. Further, the methods or methodologies for the present technology disclosed herein, including one or more systems, apparatuses, and flowcharts, in accordance with various aspects of the present disclosure, may be implemented in software, hardware, any combinations of software and hardware, a computer program or firmware incorporated in a computer readable medium for execution by a controller, a processor, a computer, or a processing system that includes one or more processors. Examples of processors include microcontrollers, microprocessors, digital signal processors (DSPs), discrete hardware circuits, gated logic, state machines, programmable logic devices (PLDs), FPGAs, and other suitable hardware configured to perform various functions described herein.

While, for simplicity, the methodologies are described herein as a series of steps or acts, it is to be understood that the claimed subject matter is not limited by the order of steps or acts, as some steps or acts may occur in different orders and/or concurrently with other acts from that shown and described herein. Further, not all illustrated steps or acts, e.g., various flowcharts, may be required to implement various methodologies according to the present technology disclosed herein. Furthermore, the methodologies disclosed herein and throughout this specification are capable of being stored on an article of manufacture to facilitate transporting and transferring such methodologies to one or more processing systems.

The term “software” as used herein is to be construed broadly to mean any instructions, instruction sets, programs, subprograms, code, program code, software modules, applications, software packages, routines, objects, executables, threads of execution, procedures, functions, etc. including firmware, microcode, middleware, software, hardware description language, or the like. The software may also refer to general software, firmware, middleware, microcode, hardware description language, or etc. As noted above, the software may be stored on a computer-readable medium.

Examples of a computer-readable medium may include a non-transitory computer-readable medium, such as, by way of example, an optical disk, a magnetic storage device, a digital versatile disk, a flash memory, random access memory (RAM), read only memory (ROM), a register, programmable ROM (PROM), erasable PROM (EPROM), electrically, erasable PROM (EEPROM), a removable disk, a flash memory device, and any other suitable medium for storing software that may be accessed and read by a processor or a processing system. It is also appreciated that one skilled in the art will recognize how best to implement the described functionality relating to adding new system functionalities to an existing network element, depending upon a particular application within design constraints.

The term “unit” or “component” as used herein means software, hardware, or any combinations thereof. A unit may be implemented as a software component, a hardware component, or any combinations thereof, including a processor, a central processing unit (CPU), a FPGA, logic, logic arrays, ASIC, DSP, microcontroller, microprocessor, etc. or any combinations thereof. The unit thus may include software components, task components, processes, procedures, functions, program code, firmware, micro-codes, circuits, data structures, tables, arrays, and variables.

The term “article of manufacture” is intended to encompass a computer program accessible from any computer-readable device, carrier, or medium. A singular form may include a plural form if there is no clearly opposite meaning in the context. Also, as used herein, the article “a” is intended to include one or more items. Further, no element, act, step, or instruction used in the present disclosure should be construed as critical or essential to the present disclosure unless explicitly described as such in the present disclosure.

As used herein, except explicitly noted otherwise, the term “comprise” and variations of the term, such as “comprising,” “comprises,” and “comprised” are not intended to exclude other additives, components, integers or steps. The terms “first,” “second,” and so forth used herein may be used to describe various components, but the components are not limited by the above terms. The above terms are used only to discriminate one component from other components, without departing from the scope of the present disclosure.

Also, the term “and/or” as used herein includes a combination of a plurality of associated items or any item of the plurality of associated items. Further, it is noted that when it is described that an element is “coupled” or “connected” to another element, the element may be directly coupled or directly connected to the other element, or the element may be coupled or connected to the other element through a third element. Also, the term “in” may include “in” and “on”.

Further, the term “include” or “have” as used herein indicates that a feature, an operation, a component, a step, a number, a part or any combination thereof described herein is present. Further, the term “include” or “have” does not exclude a possibility of presence or addition of one or more other features, operations, components, steps, numbers, parts or combinations.

Although the present technology has been illustrated with specific examples described herein for purposes of describing example embodiments, it is appreciated by one skilled in the relevant art that a wide variety of alternate and/or equivalent implementations may be substituted for the specific examples shown and described without departing from the scope of the present disclosure. As such, the present disclosure is intended to cover any adaptations or variations of the examples and/or embodiments shown and described herein, without departing from the spirit and the technical scope of the present disclosure.

What is claimed is:

1. A system for increasing an effect of advertisement, the system comprising:
a server over a network, the server being coupled to a database of advertisement contents; and
a connected vehicle coupled to the server via a wireless network, the connected vehicle including an external display and an internal display,
wherein the connected vehicle is configured to:
determine a first maximum reward route, based on input by a user of the connected vehicle, via a graphical user interface (GUI), from a starting location to a destination, wherein the first maximum reward route is determined based at least in part on: a maximum driving distance, a maximum driving time, or a sum of rewards within a route;
receive one or more advertisement contents from the server via the wireless network, the one or more advertisement contents being selected based in part on location information of the connected vehicle, local time information, or attributes of people around the connected vehicle; and
reproduce the one or more advertisement contents on the external display or the internal display.

2. The system of claim 1, wherein each of the one or more advertisement contents comprises identification information including an advertisement content identifier, an advertiser identifier, or a vehicle identification number.

3. The system of claim 2, wherein when a viewer obtains the identification information from the one or more advertisement contents reproduced on the internal or external display of the connected vehicle and the viewer takes an action based on the obtained identification information, the server is further configured to administer payment of one or more rewards to a user of the connected vehicle and/or the viewer.

4. The system of claim 3, wherein the action of the viewer comprises an access to a predetermined website based on the obtained identification information, via a mobile device of the viewer; and wherein the one or more rewards comprise a discount rental fee, an additional use time, or a credit for use next time for the connected vehicle, or any combination thereof.

5. The system of claim 1, wherein the connected vehicle is configured to determine the first maximum reward route, based on input by the user of the connected vehicle, via the GUI, from a starting location to a destination.

6. The system of claim 1, wherein the value of the sum of rewards is determined based on an expected advertisement effect, as the connected vehicle passes through a specific region, a specific road, and/or a specific store.

7. The system of claim 1, wherein the server is configured to provide a reward to the user of the connected vehicle when the user enters one or more specific keywords in response to a prompt via an in-vehicle microphone within a predetermined period.

8. The system of claim 7, wherein the reward comprises a discount rental fee, an additional use time, or a credit for use next time for the connected vehicle or any combination thereof.
